(19) United States
(12) Patent Application Publication
(10) Pub. No.: US 2025/0074085 A1
(43) Pub. Date: Mar. 6, 2025

(54) LABEL PRINTER

(71) Applicant: ZHONGSHAN POLONO ELECTRONIC TECHNOLOGY CO., LTD., Zhongshan (CN)

(72) Inventors: Xiaotong CHEN, Zhuhai (CN); Dongming LIN, Zhuhai (CN); Wenyi FAN, Zhuhai (CN); WenBin YU, Zhuhai (CN)

(73) Assignee: ZHONGSHAN POLONO ELECTRONIC TECHNOLOGY CO., LTD., Zhongshan (CN)

(21) Appl. No.: 18/954,502

(22) Filed: Nov. 20, 2024

Related U.S. Application Data
(63) Continuation of application No. PCT/CN2023/096118, filed on May 24, 2023.

(30) Foreign Application Priority Data
May 24, 2022 (CN) 202221265529.2
May 24, 2022 (CN) 202221266074.6
Apr. 27, 2023 (CN) 202321007026.X

(51) Int. Cl. B41J 11/70; B41J 3/407; B41J 15/04

(52) U.S. Cl. CPC B41J 11/706; B41J 3/4075; B41J 15/04

(57) ABSTRACT

A label printer with a paper-cutting mechanism includes a force-applying assembly operatively coupled to a paper-cutting assembly. The force-applying assembly receives an applied force and drives the paper-cutting assembly to move. The paper-cutting assembly includes a blade assembly and a paper-pressing assembly operatively coupled together, and an elastic member disposed between the blade assembly and the paper-pressing assembly. The blade assembly is supported by the force-applying assembly, while the paper-pressing assembly moves vertically relative to the blade assembly. The front-back and left-right movements of the paper-pressing assembly are restricted by the blade assembly. The paper-pressing assembly includes a paper-pressing plate and a first positioning pin, with one end of the elastic member connected to the first positioning pin. The blade assembly includes a blade and a blade holder with a second positioning pin. The other end of the elastic member is connected to the second positioning pin.

### CROSS-REFERENCE TO RELATED APPLICATIONS

The present disclosure is a continuation-in-part of International Application No. PCT/CN2023/096118, filed on May 24, 2023, which claims priority to Chinese Application No. 202221265529.2, filed on May 24, 2022, Chinese Application No. 202221266074.6, filed on May 24, 2022, and Chinese Application No. 202321007026.X, filed on Apr. 27, 2023. All of the aforementioned patent applications are hereby incorporated by reference in their entireties.

### TECHNICAL FIELD

The present disclosure relates to a label printer.

### BACKGROUND

Label printers are widely used in scenarios such as warehouse logistics and cashier operations. They generally use thermal printing to form images or text on thermal paper, after which the printed paper is outputted. To ensure smooth paper output, a paper feed roller is installed in the label printer and is driven by a drive source.

Between the paper feed roller and the drive source, there is a driving force transmission mechanism. This mechanism commonly includes a set of gears installed inside the label printer. For handheld label printers, due to their small size and limited internal space, their overall dimensions need to be effectively controlled. In this context, the driving force transmission mechanism is one of the components that can be optimized.

### SUMMARY

The present disclosure provides a label printer comprising a paper-cutting mechanism. The paper-cutting mechanism includes a force-applying assembly and a paper-cutting assembly that are operatively coupled to each other. The force-applying assembly is configured to receive an applied force and drive the paper-cutting assembly to move. The paper-cutting assembly includes a blade assembly and a paper-pressing assembly that are operatively coupled to each other, and an elastic member disposed between the blade assembly and the paper-pressing assembly. The blade assembly is supported by the force-applying assembly; the paper-pressing assembly is configured to move relative to the blade assembly along an up-down direction, and movement of the paper-pressing assembly along the front-back direction and left-right direction is restricted by the blade assembly. The paper-pressing assembly includes a paper-pressing plate and a first positioning pin, wherein one end of the elastic member is coupled to the first positioning pin. The blade assembly includes a blade holder and a blade, wherein the blade holder includes a second positioning pin, and another end of the elastic member is coupled to the second positioning pin.

Preferably, a main body of the blade holder has a guide slot, the paper-pressing assembly includes a guiding portion connected to the paper-pressing plate, the guiding portion is received within the guide slot, the paper-pressing plate is restricted by the guide slot to slide only along the up-down direction.

Preferably, the main body of the blade holder further has an installation hole in communication with the guide slot, wherein the guiding portion and the first positioning pin pass through the installation hole from the front to the back of the main body, the guiding portion is received within the guide slot.

Preferably, the blade holder further includes a bottom plate positioned below the installation hole, wherein the second positioning pin protrudes upward from the bottom plate.

Preferably, along the left-right direction, the second positioning pin has a dimension larger than that of the guide slot, wherein the main body of the blade holder has a supporting surface for supporting the blade, the supporting surface is positioned above the guide slot. The guiding portion is a guiding protrusion.

Preferably, the paper-cutting mechanism further includes a bracket, wherein the blade assembly is further supported by the bracket.

Preferably, the bracket includes a bracket body and a supporting arm provided on the bracket body, wherein one side of the blade holder is supported by the supporting arm, the front side of the blade holder is supported by the force-applying assembly.

Preferably, the bracket has a mating part, wherein a rotatable paper feeding roller is provided on a paper path of the label printer, and ends of the paper feeding roller are engaged in the mating part.

Preferably, the label printer further includes a housing, a paper compartment and a driving force output member positioned in the housing, a paper feeding roller rotatably provided on a paper path, and a transmission mechanism configured to transmit the driving force output by the driving force output member to the paper feeding roller. When viewed along the left-right direction of the label printer, at least a part of the transmission mechanism overlaps with the paper compartment. The paper compartment includes a frame forming a paper receiving cavity with an upward opening. The transmission mechanism includes an intermediate transmission assembly and a driving member, wherein the intermediate transmission assembly is configured to transmit the driving force to the driving member, and the driving member is configured to drive the paper feeding roller to rotate. The intermediate transmission assembly includes multiple gears meshing in sequence, the surface of the frame is provided with multiple limiting protrusions, each limiting protrusion corresponds to one gear, and is configured to limit a radial movement of the corresponding gear.

The above technical solution optimizes the transmission mechanism, for example, by enabling at least a part of the transmission mechanism overlap with the paper receiving cavity/compartment, thereby making the internal structure of the label printer more compact, and fully utilizing the internal space of the label printer. Consequently, the overall size of the label printer can be effectively controlled.

### BRIEF DESCRIPTION OF THE DRAWINGS

FIG. 1 is a perspective view of a label printer according to a first embodiment of the present disclosure.

FIG. 2 is a perspective view of the label printer of FIG. 1 with an upper cover assembly removed.

FIG. 3A is an exploded view of components of the label printer of FIG. 1.

FIG. 3B is a schematic view of an internal structure of a right end cover of the label printer of FIG. 1.

FIGS. 4A and 4B are perspective views of a push block in a paper-cutting mechanism of the label printer of FIG. 1.

FIG. 5 is a perspective view of a paper-pressing assembly in the paper-cutting mechanism of the label printer of FIG. 1.

FIGS. 6A and 6B are perspective views of a blade holder in the paper-cutting mechanism of the label printer of FIG. 1.

FIG. 7 is a perspective view of a blade assembly and the paper-pressing assembly coupled in the paper-cutting mechanism of the label printer of FIG. 1.

FIG. 8 is a sectional view of the blade assembly, the paper-pressing assembly, and a bracket coupled in the paper-cutting mechanism of the label printer of FIG. 1, the sectional view taken along a plane passing through a center of a left first positioning pin and perpendicular to a left-right direction.

FIG. 9 is a side view of a transmission mechanism and a paper compartment of the label printer of FIG. 1, viewed along the left-right direction with an outer housing removed.

FIG. 10 is an exploded view of components of the transmission mechanism in the label printer of FIG. 1.

FIG. 11 is an exploded view of components of a transmission mechanism in a label printer according to a second embodiment of the present disclosure.

FIG. 12 is a perspective view of a paper compartment of a label printer according to a third embodiment of the present disclosure.

FIG. 13 is a schematic view of a pressing assembly of the label printer of FIG. 12.

FIG. 14 is a side view of an upper cover assembly of the label printer of FIG. 12, viewed from front to back.

FIG. 15 is a schematic view of a pressing assembly of a label printer according to a fourth embodiment of the present disclosure.

FIG. 16 is a perspective view of an upper cover assembly of the label printer of FIG. 15, viewed from an alternative viewpoint.

### DETAILED DESCRIPTION OF THE EMBODIMENTS

The preferred embodiments of the present disclosure will be described in detail below with reference to the accompanying drawings.

### First Embodiment

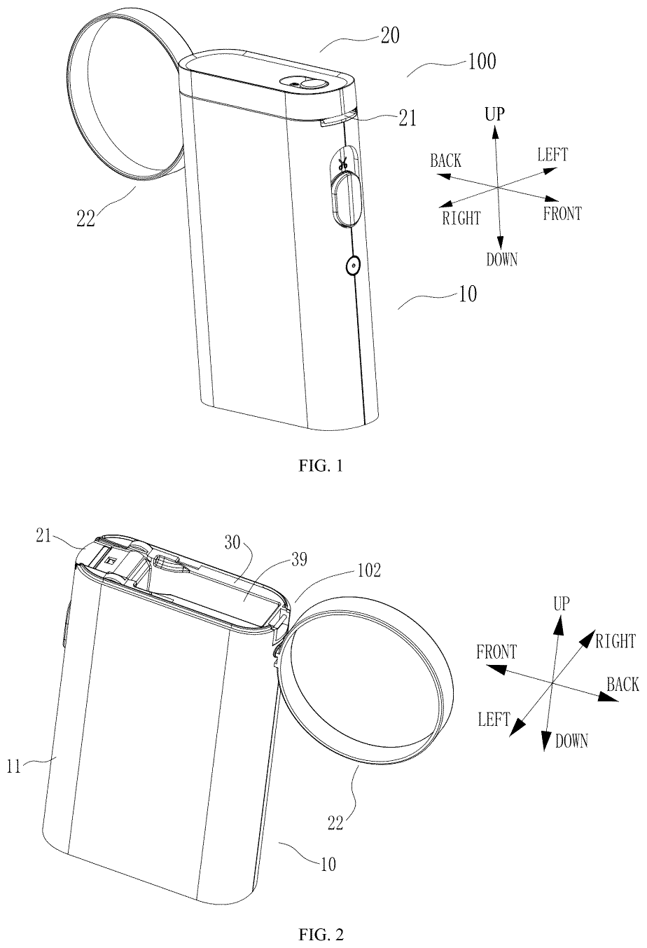

FIG. 1 is a perspective view of a label printer according to the first embodiment of the present disclosure; FIG. 2 is a perspective view of the label printer according to the first embodiment of the present disclosure with the upper cover assembly hidden.

As shown in FIGS. 1 and 2, the label printer 100 includes a main assembly 10 and an upper cover assembly 20 operatively coupled by a connecting portion 102. A paper outlet 21 is defined between the main assembly 10 and the upper cover assembly 20. A grip portion 22 is connected to either the main assembly 10 or the upper cover assembly 20 for facilitating handling of the label printer 100. The upper cover assembly 20 is pivotally mounted to the main assembly 10 for pivotal movement relative to the main assembly 10. The upper cover assembly 20 and the main assembly 10 can be locked together either mechanically or magnetically. When implementing mechanical locking, the upper cover assembly 20 further comprises an unlocking device configured such that actuation of the unlocking device releases the locking between the main assembly 10 and the upper cover assembly 20. A hinge joint between the main assembly 10 and the upper cover assembly 20 defines the connecting portion 102. The paper outlet 21 for outputting an imaging medium is formed in the main assembly 10 at a position opposite to the connecting portion 102.

For purposes of this description, the spatial orientation of the label printer 100 shall be defined with reference to its normal operating position wherein the height direction of the label printer 100 defines the up-down direction, the width direction defines the left-right direction, and the direction perpendicular to both the up-down and left-right directions defines the front-back direction. The up-down direction and left-right direction are also perpendicular to each other. A rear side of the label printer corresponds to where the main assembly 10 and the upper cover assembly 20 are pivotally coupled, and a front side is defined opposite to the rear side.

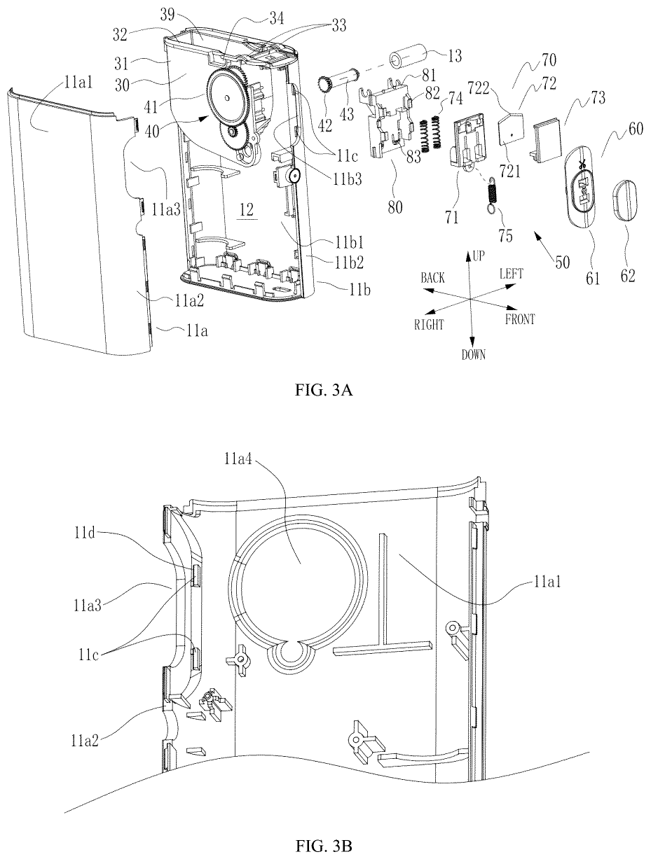

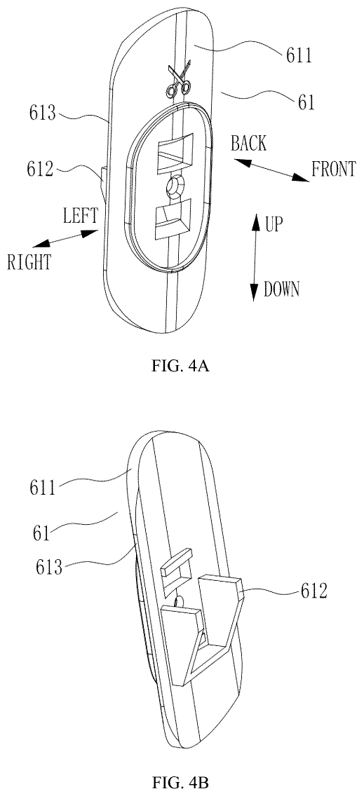

FIG. 3A is an exploded view of the components of the label printer according to the first embodiment of the present disclosure; FIG. 3B is a schematic view of the internal structure of the right end cover of the label printer according to the first embodiment of the present disclosure; FIGS. 4A and 4B are perspective views of the push block in the paper-cutting mechanism according to the first embodiment of the present disclosure.

The main assembly 10 includes a housing 11, a paper compartment 30 and a paper-cutting mechanism 50 mounted to the housing 11. At least part of the paper compartment 30 and at least part of the paper-cutting mechanism 50 are disposed in a cavity 12 formed by the housing 11. The paper-cutting mechanism 50 is configured to be fixedly mounted to either the housing 11 or the paper compartment 30. In a preferred embodiment, the housing 11 includes a first housing portion 11a and a second housing portion 11b configured to be coupled together along the left-right direction, wherein the cavity 12 is defined between the first housing portion 11a and the second housing portion 11b. A roll of imaging medium, such as paper or label paper, is accommodated within the paper compartment 30 for use during printer operation. The paper-cutting mechanism 50 is configured to cut the paper supplied to the paper outlet 21. The first housing portion 11a includes a main housing portion Hal extending in the up-down and front-back directions and an extended housing portion 11a2 coupled to the main housing portion Hal. A notch 11a3 is formed in at least the extended housing portion 11a2. The second housing portion 11b has a structure substantially similar to the first housing portion 11a, including a main housing portion 11b1 extending in the up-down and front-back directions and an extended housing portion 11b2 connected to the main housing portion 11b1. A notch 11b3 is formed in at least the extended housing portion 11b2. When the first housing portion 11a and the second housing portion 11b are joined, the notch 11a3 and notch 11b3 are opposite to each other along the left-right direction. The paper-cutting mechanism 50 is disposed within the cavity 12, with a portion of the paper-cutting mechanism 50 exposed from the notch 11a3/11b3.

The paper-cutting mechanism 50 includes a force-applying assembly 60 and a paper-cutting assembly 70 that are operatively coupled. The force-applying assembly 60 is configured to receive an applied force and actuate the paper-cutting assembly 70. The force-applying assembly 60 actuates the paper-cutting assembly 70 to perform a paper-cutting operation in response to user input. A portion of the force-applying assembly 60 is exposed through the notch 11a3/11b3. As shown in FIG. 3A, the force-applying assembly 60 includes a sliding block 61 and a push block 62 that are operatively coupled. When the push block 62 receives an upward push force, the sliding block 61 is driven to slide upward, thereby pushing the paper-cutting assembly 70 upward to perform the paper-cutting operation.

As shown in FIGS. 4A and 4B, the sliding block 61 includes a plate-shaped main board 611 and a supporting part 612 protruding from the rear surface of the main board 611. The paper-cutting assembly 70 is configured to be supported by the supporting part 612, whereby the paper-cutting assembly 70 is configured to move upward together with the main board 611. Preferably, the left and right ends 613 of the main board 611 gradually curve backward, and the thickness of the left and right ends 613 of the main board 611 gradually decreases. This generally forms a configuration wherein, along the left-right direction, the main board 611 has a thick central portion and thin ends. Accordingly, the main board 611 is configured to be mounted to the inside of the housing 11 adjacent to the cavity 12, such that the thickness of the housing 11 need not change. The thickness of the housing near the notch 11a3/11b3 may remain unchanged, without requiring a sliding groove in the housing near the notch 11a3/11b3, thereby maintaining the strength of the housing.

As shown in FIGS. 3A and 3B, at least one protrusion 11c is formed on the inside (the side where the cavity 12 is positioned) of the first housing portion 11a near the notch 11a3. A sliding groove 11d extending along the up-down direction is formed between the protrusion 11c and the first housing portion 11a. The left end/right end 613 of the main board 611 is received within the sliding groove 11d. Similarly, protrusions 11c and sliding grooves 11d are also provided on the inside of the second housing portion 11b, and the right end/left end 613 of the main board 611 is received within the sliding groove 11d. It should be noted that “thick central portion” here does not mean that the thickness of the central portion of the main board 611 along the left-right direction is greater than the thickness of both ends. Generally speaking, as long as the thickness of both ends of the main board 611 along the left-right direction enables the left and right ends of the main board 611 to be guided by the sliding groove 11d, it is sufficient. Even if the thickness of the central portion of the main board 611 along the left-right direction is the same as or smaller than the thickness of the ends, the sliding functionality of the sliding block 61 is maintained.

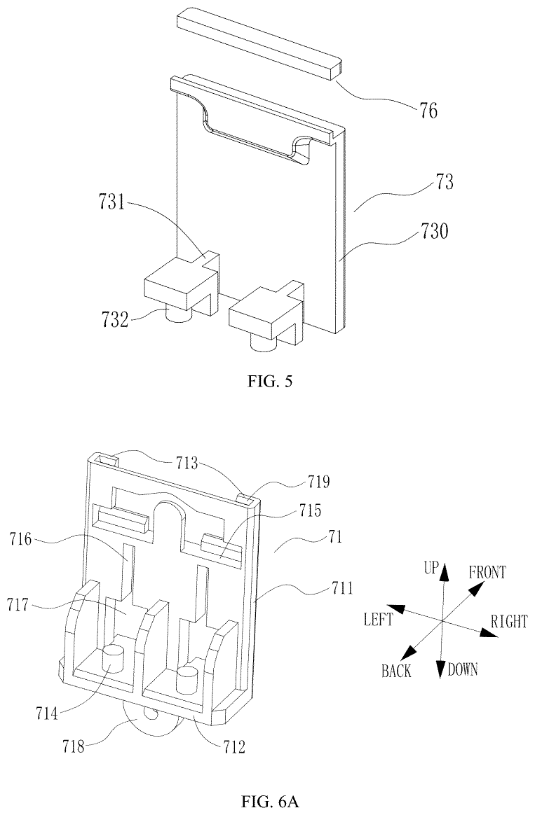

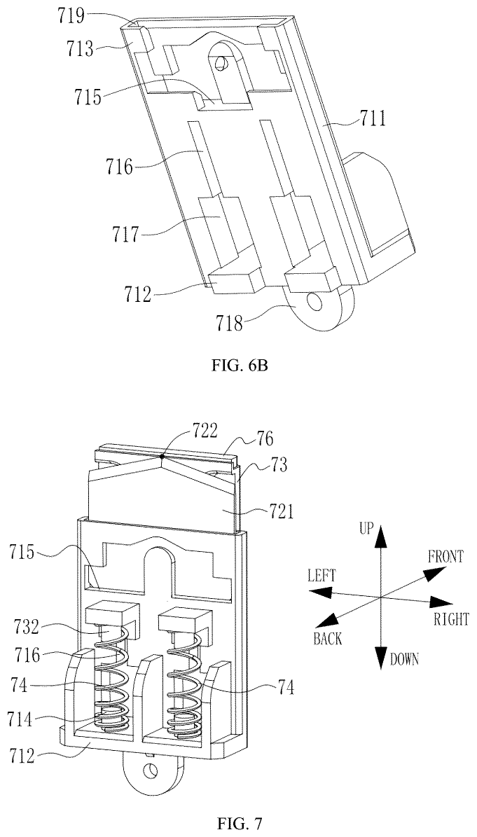

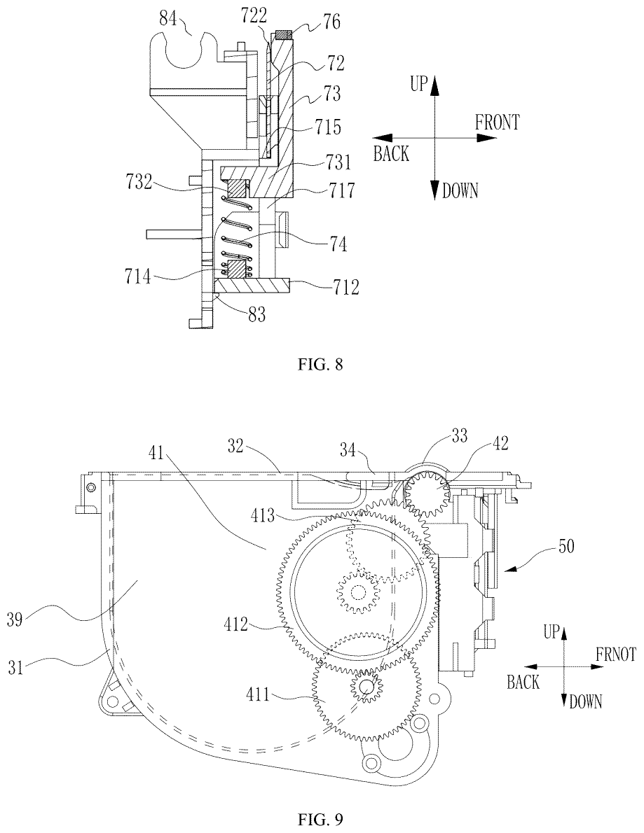

FIG. 5 is a perspective view of the paper-pressing assembly in the paper-cutting mechanism according to the first embodiment of the present disclosure; FIGS. 6A and 6B are perspective views of the blade holder in the paper-cutting mechanism according to the first embodiment of the present disclosure; FIG. 7 is a perspective view of the blade assembly and paper-pressing assembly coupled in the paper-cutting mechanism according to the first embodiment of the present disclosure; FIG. 8 is a sectional view of the blade assembly, paper-pressing assembly, and bracket coupled in the paper-cutting mechanism according to the first embodiment of the present disclosure, cut along a plane passing through the center of the left first positioning pin and perpendicular to the left-right direction.

The paper-cutting assembly 70 includes a blade assembly and a paper-pressing assembly 73 that are operatively coupled. The blade assembly is supported by the force-applying assembly 60, and the paper-pressing assembly 73 is configured to move relative to the blade assembly along the up-down direction. The paper-pressing assembly 73 is configured to move upward together with the blade assembly for a first distance to press the label paper, whereupon the paper-pressing assembly 73 remains stationary and stops moving; the blade assembly is configured to continue to move upward for a second distance to complete the paper-cutting operation. The blade assembly includes a blade holder 71 and a blade 72 that are operatively coupled. The blade 72 is fixedly mounted to the blade holder 71, and the paper-pressing plate 730 is operatively coupled to the blade holder 71, whereby the blade assembly and the paper-pressing assembly 73 are configured to be formed as an integral unit. They are configured to be pre-assembled and then coupled to other components of the label printer 100 to facilitate assembly of the paper-cutting mechanism 50 while maintaining component integrity in the blade assembly and/or in the paper-pressing assembly 73.

The paper-pressing assembly 73 includes a paper-pressing plate 730, a paper-pressing block 76 coupled to the paper-pressing plate 730, a guiding protrusion 731 connected to the paper-pressing plate 730 functioning as a guide portion, and a first positioning pin 732 coupled to the guiding protrusion 731. The paper-pressing block 76 is disposed at the upper end of the paper-pressing plate 730. The paper-pressing block 76 may be formed integrally with the paper-pressing plate 730 or formed separately. The paper-pressing block 76 may be formed of any suitable material capable of pressing paper at the paper outlet 21. In a preferred embodiment, the paper-pressing block 76 is made of a flexible material to prevent sudden resistance when pushing the force-applying assembly 60, and to enable the pressure of the paper-pressing block 76 applied to the paper to increase gradually thereby prevent the paper from wrinkling or wear.

The blade holder 71 includes a plate-shaped body 711, a front side plate 713 and a bottom plate 712 extending from the body 711 in the front and back directions, respectively. A limiting groove 719 configured to retain the blade 72 is formed between the front side plate 713 and the body 711. Preferably, the body 711 is further provided with a supporting surface 715 for supporting the blade 72. A second positioning pin 714 protrudes upward from the bottom plate 712. Preferably, the body 711 is further provided with an installation hole 717 and a guide slot 716 that are interconnected. During assembling the paper-cutting mechanism 50, the guiding protrusion 731 and the first positioning pin 732 of the paper-pressing plate 730 pass through the installation hole 717 from the front to the rear of the body 711, whereupon the guiding protrusion 731 is received within the guide slot 716. The second positioning pin 714 itself or the part where the second positioning pin 714 is positioned has a dimension greater than the guide slot 716 along the left-right direction. Consequently, the paper-pressing assembly 73 is constrained in both front-back and left-right directions by the blade assembly. The paper-pressing plate 730 is guided by the guide slot 716 to enable sliding movement solely along the up-down direction, whereby the paper-pressing plate 730 is retained within the body 711. The blade holder 71 and the paper-pressing plate 730/paper-pressing assembly 73 thus form an integrated unit.

Preferably, the paper-cutting mechanism 50/paper-cutting assembly 70 further includes an elastic member 74 disposed between the blade assembly and the paper-pressing assembly 73. The elastic member 74 is positioned between the blade holder 71 and the paper-pressing plate 730. The elastic member 74 serves as a force transmission member to transmit the force from the force-applying assembly 60 to the paper-pressing assembly 73, enabling the paper-pressing assembly 73 to move together with the blade assembly. In a preferred embodiment, the elastic member 74 is a compression spring. As shown in FIG. 7, one end of the compression spring is coupled to the first positioning pin 732, and the other end is coupled to the second positioning pin 714.

As shown in FIGS. 6A and 6B, along the up-down direction, the supporting surface 715 is positioned above the guide slot 716, wherein the dimension of the blade 72 along the up-down direction can be controlled. Preferably, the bottom plate 712 is positioned below the installation hole 717, such that the installation hole 717 and the guide slot 716 are positioned between the supporting surface 715 and the bottom plate 712. This structural configuration facilitates the dimensioning of the installation hole 717 enabling the paper-pressing plate 730 to be quickly installed, while ensuring that the movement of the paper-pressing plate 730 along the up-down direction remains unobstructed. When the label printer 100 is fully assembled, the blade holder 71/bottom plate 712 is supported by the force-applying assembly 60/supporting part 612. Specifically, the front side of the blade holder 71/bottom plate 712 is supported by the supporting part 612 of the force-applying assembly 60.

As shown in FIG. 3A, the paper-cutting mechanism 50 further includes a bracket 80, wherein the bracket 80 is fixed in the cavity 12 by means such as shaft connection or snap-fit connection with the paper compartment 30 and/or the housing 11. The paper-cutting assembly 70/blade assembly is further supported by the bracket 80. Specifically, the bracket 80 supports the rear side of the blade holder 71/bottom plate 712, such that the front side and rear side of the bottom plate 712 are both supported, enabling the paper-cutting assembly 70 to be stably positioned. The bracket 80 includes a bracket body 81 and a supporting arm 83 and a limiting plate 82 disposed on the bracket body 81. One side of the blade holder 71/bottom plate 712 is supported by the supporting arm 83 (as shown in FIG. 8). The blade assembly is constrained in both front-back and left-right directions by the limiting plate 82. The body 711 of the blade holder 71 is guided by the limiting plate 82 for movement solely along the up-down direction. Accordingly, the paper-cutting assembly 70 of the paper-cutting mechanism 50 can be positioned relative to the bracket 80, whereby the paper-cutting assembly 70 is configured to move relative to the bracket 80 and complete the paper-cutting operation in response to an upward pushing force from the force-applying assembly 60. During the upward movement of the paper-cutting assembly 70, the blade holder 71, blade 72, and paper-pressing assembly 73 first move upward together, whereupon the paper-pressing assembly 73 presses the label paper and remains stationary, while the blade holder 71 and blade 72 continue to move upward relative to the paper-pressing assembly 73 until the paper-cutting operation is completed.

The blade 72 includes a blade body 721 and a tip 722 positioned at the upper end of the blade body 721. The tip 722 is configured to be conical for enhanced cutting of the paper. When the paper-cutting mechanism 50 is fully assembled, along the up-down direction, the tip 722 of the blade 72 is lower than/does not exceed the uppermost part of the paper-pressing assembly 73. In other words, along the up-down direction, the highest point of the blade 72 does not exceed the uppermost part of the paper-pressing assembly 73. This positioning of the blade 72 below the paper-pressing assembly 73 both protects the blade 72 from breakage and prevents the blade 72 from contacting the paper before the paper-pressing assembly 73, which would result in the paper being cut unevenly. In a preferred embodiment, along the up-down direction, the distance between the tip 722 of the blade 72 and the uppermost part of the paper-pressing assembly 73 ranges from 0.5 mm to 2 mm, more preferably, the distance is 1 mm. Consequently, after the paper-pressing assembly 73 completes the paper pressing operation, the blade 72 is configured to subsequently perform the cutting, while maintaining the continuity of the paper-cutting operation and reducing the distance the blade 72 needs to move upward. Correspondingly, the distance the user needs to push the force-applying assembly 60 to move is also shortened.

Operation of the paper-cutting mechanism 50 is as follows.

The user actuates the push block 62 to cause the sliding block 61 to slide upward along the sliding groove 11d. Simultaneously, the sliding block 61 drives the blade holder 71 to slide upward along the limiting plate 82 of the bracket 80. Through the elastic member 74, the paper-pressing plate 730 is pushed upward, and the paper-pressing block 76 gradually presses the paper and remains stationary. Meanwhile, the blade 72 continues to move upward with the blade holder 71, whereupon the elastic member 74 undergoes elastic deformation, and the tip 722 of the blade 72 pierces the middle of the paper and gradually extends to both sides until the paper is completely cut. The blade 72 is then received within a receiving cavity (not shown) formed within the upper cover assembly 20 opposite to the blade 72.

As shown in FIG. 3A, the paper-cutting mechanism 50 further includes a reset member 75 coupled to the blade holder 71 or paper-pressing plate 730. The reset member 75 is further coupled to the housing 11 or paper compartment 30. During the upward movement of the push block 62, the reset member 75 undergoes elastic deformation. After the paper-cutting operation is completed, when the user releases the pushing force from the push block 62, the components of the paper-cutting mechanism 50 return to their original positions under the elastic resetting force of the reset member 75. In a preferred embodiment, the elastic member 74, first positioning pin 732, second positioning pin 714, and supporting arm 83 each comprise two components, spaced apart along the left-right direction, thereby ensuring the movement of the paper-cutting mechanism 50 more stable.

The label printer 100 feeds paper from the paper compartment 30 to the paper outlet 21 through a paper feeding roller 13. The paper feeding roller 13 is positioned on the paper path and is mounted in a rotatable manner. Accordingly, the label printer 100 further includes a transmission mechanism 40 for driving the rotation of the paper feeding roller 13.

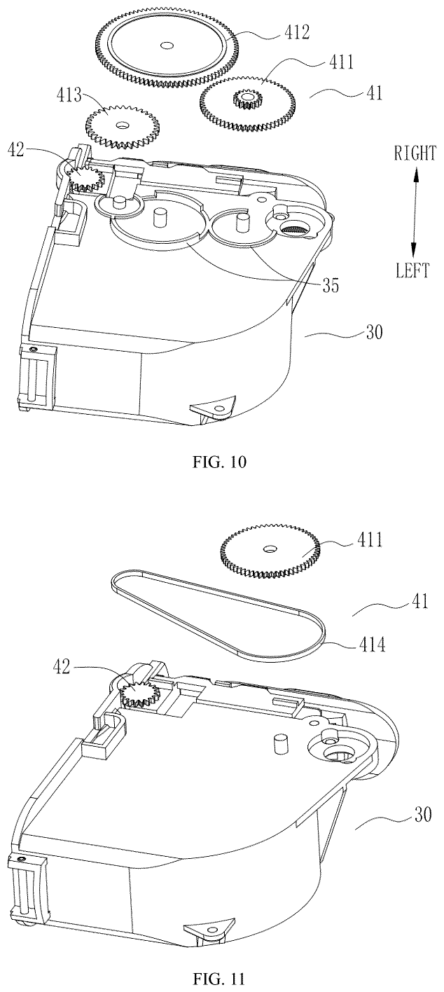

FIG. 9 is a side view of the transmission mechanism and paper compartment of the label printer according to the first embodiment of the present disclosure, viewed along the left-right direction with the outer housing hidden; FIG. 10 is an exploded view of components of the transmission mechanism in the label printer according to the first embodiment of the present disclosure.

As shown in FIG. 3A, the paper compartment 30 includes a frame 31 forming a paper receiving cavity 39 with an upward opening, a rim 32 positioned above the paper receiving cavity 39, and two protrusions 33 positioned at the front of the paper receiving cavity 39. The two protrusions 33 are spaced apart along the left-right direction, defining an opening between them that exposes the paper feeding roller 13. The rim 32 extends along the outer surface of the frame 31. In a preferred embodiment, the rim 32 extends around the opening of the paper receiving cavity 39, for coupling the paper compartment 30 with the housing 11. Preferably, the paper compartment 30 is further provided with a locking part 34. The locking part 34 is configured to lock the upper cover assembly 20 with the main assembly 10.

The transmission mechanism 40 is configured to transmit a driving force output by a motor/driving force output member (not shown) disposed in the cavity 12 to the paper feeding roller 13. As shown in FIG. 3A, the transmission mechanism 40 includes an intermediate transmission assembly 41 and a driving gear 42 serving as a driving member. The intermediate transmission assembly 41 includes multiple meshing gears. The intermediate transmission assembly 41 transmits the driving force to the driving gear 42, whereby the driving gear 42 drives the paper feeding roller 13 to rotate. The driving member is a driving gear 42 coupled to a transmission shaft 43 in this embodiment.

The intermediate transmission assembly 41 includes a first gear 411, a second gear 412, and a third gear 413 that mesh in sequence. Specifically, the first gear 411 receives the driving force, and the third gear 413 meshes with the driving gear 42. When the paper feeding roller 13 is a hollow cylindrical roller, the transmission mechanism 40 further includes a transmission shaft 43 coupled to the driving gear 42. The paper feeding roller 13 is mounted to the outer surface of the transmission shaft 43. The driving gear 42 drives the transmission shaft 43 to rotate, which in turn drives the paper feeding roller 13 to rotate. When the paper feeding roller 13 is a roller with a transmission shaft 43, the transmission shaft 43 is configured to be either directly coupled to the driving gear 42, or coupled via an intermediate component disposed between the driving gear 42 and the transmission shaft 43 for transmitting the driving force. The transmission shaft 43 is mounted to the paper-cutting mechanism 50. The two ends of the paper feeding roller 13/transmission shaft 43 are opposite to the protrusions 33 and are fixed by being engaged with the snap-fit part 84 of the bracket 80. Specifically, the paper feeding roller 13/transmission shaft 43 is clamped between the protrusions 33 and the snap-fit part 84 of the bracket. This configuration both simplifies installation and enables the paper feeding roller 13/transmission shaft 43 to be stably fixed. In this configuration, the transmission shaft 43 is coaxial with the paper feeding roller 13.

As shown in FIG. 9, when viewed along the left-right direction, at least a portion of the transmission mechanism 40 overlaps with the paper receiving cavity 39/paper compartment 30. This configuration facilitates reduction of the overall size of the label printer 100, or while maintaining the overall size of the label printer 100 unchanged, enables an increase in the volume of the paper compartment 30, thereby reducing the frequency of paper replacement. Alternatively, while maintaining the overall size of the label printer 100 and the volume of the paper compartment 30 unchanged, the configuration provides increased usable space in the cavity 12, thus enhancing the design freedom of the label printer 100, for example, enabling increased battery capacity of the label printer 100, or adding more functions, etc.

As shown in FIG. 10, the surface of the frame 31 of the paper compartment 30 is further provided with multiple limiting protrusions 35. Each limiting protrusion 35 corresponds to a gear, wherein the radial movement of each gear is restricted. Preferably, as shown in FIG. 9, both the first gear 411 and the second gear 412 are double gears. Along the left-right direction, the large gear portion of the first gear 411 is closer to the frame 31 than the small gear portion, while the large gear portion of the second gear 412 is farther from the frame 31 than the small gear portion. When the transmission mechanism 40 is fully assembled, the large gear portion of the second gear 412 is positioned at the location farthest from the frame 31. A portion of the large gear portion of the first gear 411 and a portion of the third gear 413 are both positioned between the large gear portion of the second gear 412 and the frame 31 and are thus protected.

As shown in FIG. 3B, the first housing portion 11a further includes a recessed part 11a4 recessed from the inside surface adjacent the cavity 12 in the direction away from the cavity 12. The recessed part 11a4 is opposite to the large gear portion of the second gear 412. Consequently, the second gear 412 is constrained by the first housing portion 11a.

### Second Embodiment

FIG. 11 is an exploded view of components of the transmission mechanism in the label printer according to the second embodiment of the present disclosure.

As illustrated in FIG. 11, the transmission mechanism 40 in this embodiment has a modified configuration compared to the first embodiment. The intermediate transmission assembly 41 of the transmission mechanism 40 includes a first gear 411 configured to receive driving force and a belt 414 positioned between the first gear 411 and the driving gear 42 serving as a driving member. Accordingly, in this embodiment, the intermediate transmission assembly 41 no longer employs gear meshing to transmit the driving force, but uses the belt 414 to directly transmit the driving force from the first gear 411 to the driving gear 42. Not only can multiple gears of the intermediate transmission assembly 41 be omitted, enabling the internal structure of the label printer 100 more compact and reducing the cost of the label printer 100, but the efficiency of driving force transmission is also higher. When viewed along the left-right direction, at least a portion of the intermediate transmission assembly 41 overlaps with the paper receiving cavity 39/paper compartment 30.

It can be understood that the belt 414 may include toothed surfaces or non-toothed surfaces. When the belt 414 has non-toothed surfaces, the driving force is transmitted between the belt 414 and the first gear 411 and between the belt 414 and the driving gear 42 via static friction, wherein the first gear 411 may alternatively be configured as a transmission wheel with a rough surface. When the surface of the belt 414 has toothed surfaces, the engagement between the belt 414 and the first gear 411 and the engagement between the belt 414 and the driving gear 42 are achieved through tooth meshing. Similarly, the driving gear 42 may alternatively be replaced by a transmission wheel with a rough surface. Such configurations enhance transmission efficiency. The transmission wheel and the first gear 411 may be collectively referred to as the driving member. The driving member may be a transmission wheel with a rough surface coupled to the transmission shaft 43.

As described above, through optimization of the transmission mechanism 40, such as positioning at least a portion of the transmission mechanism 40 to overlap with the paper receiving cavity 39/paper compartment 30, or omitting multiple gears of the intermediate transmission assembly 41, the internal structure of the label printer 100 becomes more compact, maximizing utilization of the internal space of the label printer 100, thereby effectively controlling the overall size of the label printer 100.

### Third Embodiment

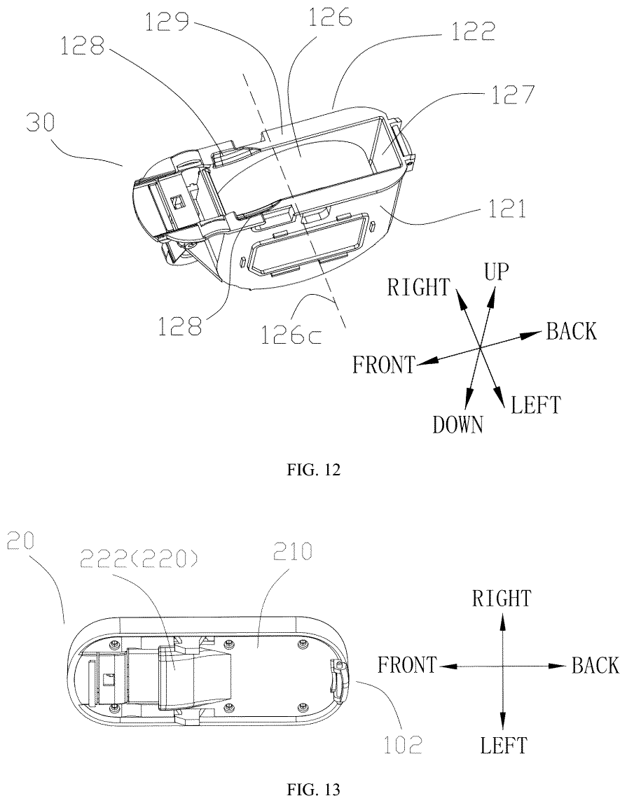

FIG. 12 is a perspective view of the paper compartment according to the third embodiment of the present disclosure.

As shown in FIG. 12, the paper compartment 30 includes a left wall 121 and a right wall 122 disposed opposite each other along the left-right direction. A roll-shaped imaging medium 126 (e.g., paper/label paper) is disposed between the left wall 121 and the right wall 122 of the paper compartment 30 defining an interior space 127 corresponding to paper cavity 39. The roll-shaped imaging medium 126 is configured to rotate around an axis 126c. The left wall 121 and the right wall 122 have dimensions in both the up-down direction and front-back direction that are greater than the corresponding dimensions of the roll-shaped imaging medium 126, whereby the paper compartment interior 127 is configured to completely accommodate the roll-shaped imaging medium 126. The paper compartment 30 further includes at least one clearance portion 128 formed on either left wall 121 or right wall 122. The clearance portion 128 is formed by being recessed downward from an upper surface 129 of the rim 32 of the paper compartment 30, wherein the upper surface 129 faces the upper cover assembly 20. The clearance portion 128 is positioned closer to the paper outlet 21 relative to the connecting portion 102. The clearance portion 128 is configured to cooperate with a protrusion 222 or elastic member 224 of the upper cover assembly 20 as further detailed herein.

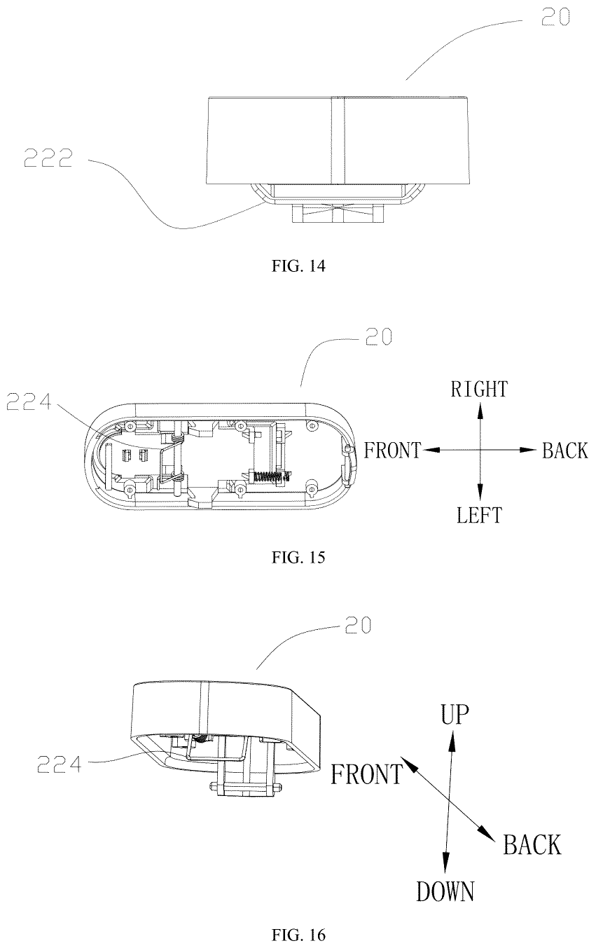

FIG. 13 is a schematic view of the pressing assembly according to the third embodiment of the present disclosure; FIG. 14 is a side view of the upper cover assembly according to the third embodiment of the present disclosure, viewed from front to back.

The upper cover assembly 20 includes a pressing assembly 220 facing the paper compartment interior. When the label printer is operating, the pressing assembly 220 presses the paper. The paper-pressing assembly 220 is positioned on the side closer to the paper outlet 21 relative to the connecting portion 102. When the upper cover assembly 20 is closed, the pressing assembly 220 is positioned opposite to the clearance portion 128. As shown in FIGS. 13 and 14, the upper cover assembly 20 includes a bottom wall 210 facing the main assembly 10. The bottom wall 210 is provided with a pressing assembly 220 for tensioning the roll-shaped imaging medium 126. The pressing assembly 220 includes a protrusion 222 protruding toward the paper compartment 30. The protrusion 222 protrudes from the bottom wall 210 toward the interior of the paper compartment 30. The protrusion 222 is positioned on the side closer to the paper outlet 21 relative to the connecting portion 102. When the upper cover assembly 20 is closed, the protrusion 222 is positioned opposite to the clearance portion 128 positioned in the paper compartment 30, and the protrusion 222 is positioned between the roll-shaped imaging medium 126 and the paper outlet 21. Starting from the end of the protrusion 222 closest to the connecting portion 102 and ending at the end farthest from the connecting portion 102, the vertical distance from the protrusion 222 to the bottom wall 210 gradually increases. The protrusion 222 is configured to tension the roll-shaped imaging medium 126 during paper output, so that the roll-shaped imaging medium 126 can be cut evenly and quickly by the paper-cutting mechanism 50. Additionally, the protrusion 222 can also prevent the roll-shaped imaging medium 126 from moving toward the paper outlet 21.

### Fourth Embodiment

FIG. 15 is a schematic view of the pressing assembly according to the fourth embodiment of the present disclosure; FIG. 16 is a perspective view of the upper cover assembly according to the fourth embodiment of the present disclosure from an alternative viewpoint.

In the fourth embodiment, the pressing assembly includes an elastic member 224. As shown in FIGS. 15 and 16, the elastic member 224 can replace the protrusion 222. Preferably, the elastic member 224 may be a compression spring. The elastic member 224 protrudes toward the paper compartment interior 127/paper receiving cavity 39 and is inclined toward the side where the paper outlet 21 is positioned. The elastic member 224 is provided on the bottom wall 210 on the side closer to the paper outlet 21 relative to the connecting portion 102. When the upper cover assembly 20 is closed, the elastic member 224 is positioned opposite to the clearance portion 128 positioned in the paper compartment 30, and the elastic member 224 is positioned between the roll-shaped imaging medium 126 and the paper outlet 21. The elastic member 224 is configured to tension the roll-shaped imaging medium 126 during paper output, thereby enabling the roll-shaped imaging medium 126 to be cut evenly and quickly by the paper-cutting mechanism 50, while also preventing the roll-shaped imaging medium 126 from moving toward the paper outlet 21. The pressing assembly is provided on the side closer to the paper outlet relative to the connecting portion.

The elastic member 224 is further configured to provide variable pressure to the roll-shaped imaging medium 126, preventing excessive pressure that could make it difficult to pull from the outside or cause the roll-shaped imaging medium 126 to break inside the paper compartment 127/paper receiving cavity 39.

As mentioned above, the pressing assembly 220 is arranged on the bottom wall 210 of the upper cover assembly 20 of the label printer 100. The pressing assembly 220 can be configured as a protrusion or as an elastic member. The pressing assembly 220 can tension the imaging medium during cutting, allowing the imaging medium to be cut evenly and quickly.

What is claimed is:

1. A label printer, comprising:
a paper-cutting mechanism comprising a force-applying assembly and a paper-cutting assembly operatively coupled to each other, wherein the force-applying assembly is configured to receive an applied force and drive the paper-cutting assembly to move;
the paper-cutting assembly comprises a blade assembly and a paper-pressing assembly operatively coupled to each other, and an elastic member is disposed between the blade assembly and the paper-pressing assembly;
the blade assembly is supported by the force-applying assembly, the paper-pressing assembly is configured to move relative to the blade assembly along an up-down direction, and movement of the paper-pressing assembly along a front-back direction and a left-right direction is restricted by the blade assembly;
the paper-pressing assembly comprises a paper-pressing plate and a first positioning pin, and one end of the elastic member is connected to the first positioning pin; and
the blade assembly comprises a blade holder and a blade, the blade holder comprises a second positioning pin, and another end of the elastic member is connected to the second positioning pin.

2. The label printer according to claim 1, wherein a main body of the blade holder comprises a guide slot, the paper-pressing assembly comprises a guiding portion connected to the paper-pressing plate, the guiding portion is received within the guide slot, so that the paper-pressing plate is restricted by the guide slot to slide only along the up-down direction.

3. The label printer according to claim 2, wherein the main body of the blade holder further comprises an installation hole in communication with the guide slot, the guiding portion and the first positioning pin pass through the installation hole from front to back of the main body, and the guiding portion is further configured to be received within the guide slot.

4. The label printer according to claim 3, wherein the blade holder further comprises a bottom plate positioned below the installation hole, and the second positioning pin protrudes upward from the bottom plate.

5. The label printer according to claim 2, wherein, along the left-right direction, the second positioning pin has a dimension larger than that of the guide slot, the main body of the blade holder comprises a supporting surface for supporting the blade, the supporting surface is positioned above the guide slot, and the guiding portion is a guiding protrusion.

6. The label printer according to claim 1, wherein each of the elastic member, the first positioning pin and the second positioning pin comprises two members spaced apart along the left-right direction, and the elastic member is a compression spring.

7. The label printer according to claim 1, wherein the blade is fixedly mounted to the blade holder, and along the up-down direction, a highest point of the blade does not exceed an uppermost part of the paper-pressing assembly.

8. The label printer according to claim 1, wherein the paper-pressing assembly further comprises a paper-pressing block connected to the paper-pressing plate, and the paper-pressing block is positioned at an upper end of the paper-pressing plate.

9. The label printer according to claim 8, wherein the paper-pressing block is made of a flexible material.

10. The label printer according to claim 1, wherein the force-applying assembly comprises a sliding block, the sliding block comprises a main board and a supporting part, the paper-cutting assembly is supported by the supporting part, thereby enabling the paper-cutting assembly to move upward together with the main board; after the blade assembly and the paper-pressing assembly move upward together for a first distance, the paper-pressing assembly presses a label paper and remains stationary, and the blade assembly continues to move upward for a second distance to complete a paper-cutting operation.

11. The label printer according to claim 10, wherein the main board is mounted to an inner side of a housing of the label printer, and the supporting part protrudes from a back surface of the main board.

12. The label printer according to claim 10, wherein left and right ends of the main board gradually curve backward, and a thickness at the left and right ends of the main board gradually decreases.

13. The label printer according to claim 1, wherein the paper-cutting mechanism further comprises a bracket, and the blade assembly is further supported by the bracket.

14. The label printer according to claim 13, wherein the bracket comprises a bracket body and a supporting arm provided on the bracket body, one side of the blade holder is supported by the supporting arm, and a front side of the blade holder is supported by the force-applying assembly.

15. The label printer according to claim 14, wherein the supporting arm comprises two supporting arms.

16. The label printer according to claim 13, wherein the bracket comprises a limiting plate positioned therein, movement of the blade assembly along the front-back direction is restricted by the limiting plate, and the main body of the blade holder is restricted by the limiting plate to move only along the up-down direction.

17. The label printer according to claim 13, wherein the bracket comprises a mating part, a rotatable paper feeding roller is provided on a paper path of the label printer, and ends of the paper feeding roller are engaged in the mating part.

18. The label printer according to claim 1, wherein the paper-cutting mechanism further comprises a reset member connected to the blade holder or the paper-pressing plate; after a paper-cutting operation is completed, the reset member exerts an elastic resetting force, thereby causing components of the paper-cutting mechanism to return to their original positions.

19. The label printer according to claim 1, further comprising: a housing, a paper compartment and a driving force output member positioned in the housing, a paper feeding roller rotatably provided on a paper path, and a transmission mechanism configured to transmit a driving force output by the driving force output member to the paper feeding roller; wherein
when viewed along the left-right direction of the label printer, at least a part of the transmission mechanism overlaps with the paper compartment;
the paper compartment comprises a frame forming a paper receiving cavity with an upward opening; and
the transmission mechanism comprises an intermediate transmission assembly and a driving member, the intermediate transmission assembly is configured to transmit the driving force to the driving member, and the driving member is configured to drive the paper feeding roller to rotate; the intermediate transmission assembly comprises multiple gears meshing in sequence, and a surface of the frame is provided with multiple limiting protrusions, each limiting protrusion corresponds to one gear and is configured to limit a radial movement of the corresponding gear.

20. The label printer according to claim 19, wherein the intermediate transmission assembly comprises a first gear, a second gear and a third gear meshing in sequence, the driving member comprises a driving gear, the first gear is configured to receive the driving force, and the third gear meshes with the driving gear; the housing comprises a first housing portion and a second housing portion coupled along the left-right direction, the first housing portion comprises a recessed part recessed from an inner side, the recessed part is opposite to the second gear, and the recessed part is configured to limit a movement of the second gear.
